(19) United States
(12) Patent Application Publication
(10) Pub. No.: US 2015/0306826 A1
(43) Pub. Date: Oct. 29, 2015

(54) METHOD AND PLACEMENT MACHINE FOR PLACING AND ATTACHING STRIP SECTIONS TO A PART TO BE PRODUCED

(71) Applicant: DIEFFENBACHER GMBH MASCHINEN-UND ANLAGENBAU, Eppingen (DE)

(72) Inventors: Robert E. Borgmann, Eppingen (DE); Don Evans, Eppingen (DE); Christina McClard, Eppingen (DE)

(73) Assignee: Dieffenbacher GmbH Maschinen-und Anlagenbau, Eppingen (DE)

(21) Appl. No.: 14/647,390

(22) PCT Filed: Dec. 1, 2013
(86) PCT No.: PCT/EP2013/075190

§ 371 Date: May 26, 2015

Related U.S. Application Data
(60) Provisional application No. 61/731,596, filed on Nov. 30, 2012.

(51) Int. Cl. B29C 70/38; B29C 70/54

(52) U.S. Cl. CPC B29C 70/386; B29C 70/545

(57) ABSTRACT

A layup machine for laying up and tacking sections of tape on a part to be produced, comprises: a first material drive/supply unit for supplying tape materials; first gripping means for drawing sections of tape from the first material drive/supply unit and for positioning the sections of tape in guide ways; a first cutter assembly for cutting to length the section of tape from the first material drive/supply unit; a motion table; and at least one tape tacking unit for placing on a tooling surface of a motion table and for tacking the sections of tape; characterized in that the layup machine furthermore comprises a second material drive/supply unit for supplying tape material; second gripping means for drawing sections of tape from the first material drive/supply unit and for positioning the sections of tape in guide ways; and a second cutter assembly for cutting to length the sections of tape from the first material drive/supply unit.

This application is related to U.S. Pat. No. 6,607,626, issued Aug. 19, 2003; U.S. Pat. No. 6,939,423, issued Sep. 6, 2005; U.S. Pat. No. 7,235, 149, issued Jun. 26, 2007; U.S. Pat. No. 8,007,894, issued Aug. 30, 2011; U.S. Pat. No. 8,048,253, issued Nov. 1, 2011; U.S. Pat. No. 8,168,029, issued May 1, 2012; U.S. patent application Ser. No. 13/435,006, filed Mar. 30, 2012; and U.S. patent application Ser. No. 13/557,621, filed Jul. 25, 2012, all of which are herein incorporated by reference in their entirety.

### BACKGROUND

1. Field of the Invention

The present embodiments relate generally to advanced composites and, more particularly, to systems and methods for increasing the rate of layup of an automated layup system. The embodiments relate to the equipment and systems used to manufacture advanced composite components by means of an automated layup process, utilizing materials that are typically supplied in the form of spooled tape.

2. Background of the Invention

Modern, automated layup systems generally use multiple separate subsystems for carrying out the various functions of unwinding, supplying, cutting, placing, and tacking a section of tape on a specific position. Since many of these functions normally run in serial, the net productivity of the overall layup machine is dependent on the highest speed at which the individual subsystems are capable of operating.

The speed of the subsystem which is used to draw a section of tape to length and position it in relation to the tooling surface has a substantial effect on the overall productivity of the layup machine. In general, such systems are configured with a gripping device, which is attached to a linear actuator. The gripping device grasps the leading edge of a section of tape and draws it along a row of guide ways into the desired length, as established by the layup program for the determined part to be produced. Unfortunately, the maximum achievable speed and the acceleration of the linear actuator are subject to practical restrictions, which originate from a combination of multiple factors, such as friction, packing restrictions, and the mass of the gripping mechanism and associated parts. In addition, the maximum achievable force which the gripping device can exert on the tape determines the maximum acceleration rate at which it can reliably draw the tape without slipping.

The necessity therefore exists for increased layup rates and increased productivity of an overall automated layup system.

### SUMMARY

The above and other objects of the invention are achieved by a layup system and a method for laying up sections of tape as defined by independent Claims 1 and 9. Further preferred embodiments are set forth in the dependent claims.

In a first aspect, a method is provided for laying up and tacking sections of tape on a part to be produced, comprising: supplying tape material using a first material drive/supply unit to a predetermined distance beyond a first cutter assembly; grasping the leading edge of a section of tape from the first material drive/supply unit using a first gripping means; moving the first gripping means over a distance, which corresponds to the desired length of the section of tape, in a direction away from the first cutter assembly; severing the end of the section of tape from the first material drive/supply unit using the first cutter assembly; moving the first gripping means further in the direction away from the first cutter assembly, until the section of tape is positioned at a desired point in the guide ways; first moving of a motion table into a position to receive the tape course; placing the section of tape provided by the first material drive/supply unit on a tooling surface of the motion table and tacking it by way of a first tape tacking section; and moving the first gripping means back into a position adjoining the first cutter assembly, characterized in that the method further comprises: supplying tape material using a second material drive/supply unit to a predetermined distance beyond a second cutter assembly; grasping the leading edge of a section of tape from the second material drive/supply unit using a second gripping means; moving the second gripping means over a distance, which corresponds to the desired length of the section of tape, in a direction away from the second cutter assembly; severing the end of the section of tape from the second material drive/supply unit using a second cutter assembly; moving the second gripping means further in the direction away from the second cutter assembly (7; 20) until the section of tape is positioned at a desired point in guide ways; second moving of a motion table into a position for receiving the tape course; placing the section of tape provided by the second material drive/supply unit on the tooling surface of the motion table and tacking it by way of the first or a second tape tacking unit; and moving the second gripping mechanism back into a position adjoining the second cutter assembly.

The first moving of the motion table into a position for receiving the tape course can preferably be performed simultaneously with the positioning of the section of tape supplied by the first material drive/supply unit in the guide ways, and the second moving of the motion table into a position for receiving the tape course can preferably be performed simultaneously with the positioning of the section of tape supplied by the second material drive/supply unit into the guide ways.

Furthermore, the first gripping means can preferably be formed by a first tape gripping mechanism, which is mounted on a first linear actuator, and the second gripping means can be formed by a second tape gripping mechanism, which is mounted on a second linear actuator; and furthermore the supply of tape material using the second material drive/supply unit to a predetermined distance beyond the second cutter assembly is performed simultaneously with the positioning of the section of tape supplied by the first material drive/supply unit in the guide ways, and the supply of tape material using the first material drive/supply unit to a predetermined distance beyond the first cutter assembly is performed simultaneously with the positioning of the section of tape supplied by the second material drive/supply unit in the guide ways.

Alternatively and particularly preferably, the first and the second gripping means can also be formed by a first gripping mechanism or a second gripper of a tape gripping arrangement, which is mounted on a linear actuator, wherein the first linear actuator has a movement range which enables the first gripping mechanism to grasp material which is provided by the first material drive/supply unit, and enables the second gripping mechanism to grasp material which is provided by the second material drive/supply unit; and furthermore after the placement of the section of tape provided by the first material drive/supply unit on a tooling surface of the motion table and tacking it by way of the first tape tacking unit, the supply of tape material using the second material drive/supply unit to a predetermined distance beyond the second cutter assembly is performed and the linear actuator moves the tape gripping arrangement over the remaining distance to place it in position for the access to material which was provided by the second material drive/supply unit, and after the placement of the section of tape provided by the second material drive/supply unit on the tooling surface and tacking it by way of the first tape tacking unit, the supply of tape material using the first material drive/supply unit to a predetermined distance beyond the first cutter assembly is performed and the linear actuator moves the tape gripping arrangement over the remaining distance to place it in position for the access to material which was provided by the first material drive/supply unit.

Furthermore, the first gripping means can alternatively be formed by a first tape gripping mechanism, which is mounted on a first linear actuator, and the second gripping means can be formed by a second tape gripping mechanism, which is mounted on a second linear actuator; wherein furthermore the first material drive/supply unit, the first tape gripping mechanism, the first linear actuator, the first cutter assembly, material guide ways, and a first tape tacking unit are comprised in a first layup head unit; the second material drive/supply unit, the second tape gripping mechanism, the second linear actuator, the second cutter assembly, material guide ways, and a second tape tacking unit are comprised in a second layup head unit; the first layup head unit and the second layup head unit are configured to alternate during the drawing, placing, and tacking of sections of tape on the tooling surface of the motion table; and furthermore, simultaneously with the positioning of the section of tape supplied by the first material drive/supply unit in the guide ways, the first moving of the motion table into a position for receiving the tape course at a position below the first layup head unit, the supply of tape material using the second material drive/supply unit to a predetermined distance beyond the second cutter assembly, and the grasping of the leading edge of a section of tape by the second material drive/supply unit using the second gripping means are performed; during the tacking of the section of tape provided by the first material drive/supply unit by way of the first tape tacking unit, the grasping of the leading edge of a section of tape from the second material drive/supply unit using the second gripping means, the moving of the second gripping means over the distance, which corresponds to the desired length of the section of tape, in the direction away from the second cutter assembly, and the severing of the end of the section of tape from the material drive/supply unit using a second cutter assembly are performed; and during the tacking of the section of tape provided by the second material drive/supply unit by way of the second tape tacking unit, the moving of the first gripping means over the distance, which corresponds to the desired length of the section of tape, in the direction away from the first cutter assembly, and the severing of the end of the section of tape from the first material drive/supply unit using the first cutter assembly are performed.

Furthermore, it can preferably be provided that after the tacking of the section of tape provided by the first material drive/supply unit by way of the first tape tacking unit, the first tape tacking unit retracts, while the movement of the first gripping mechanism back into a position adjoining the first cutter assembly is performed, and the motion table returns to the position below the second layup head unit; while the motion table moves to the position below the second layup head unit, the movement of the gripping mechanism further in the direction away from the first cutter assembly, until the section of tape is positioned at the desired point in the guide ways, is performed; after the tacking of the section of tape provided by the second material drive/supply unit by way of the second tape tacking unit, the second tape tacking unit retracts, while the movement of the second gripping mechanism back into a position adjoining the second cutter assembly is performed, and the motion table returns to the position below the first layup head unit, and while the motion table moves to the position below the first layup head unit, the movement of the first gripping mechanism back in the direction away from the first cutter assembly until the section of tape is positioned at the desired point in the guide ways is performed.

It can preferably be provided that the first gripping means and the second gripping means alternately draw sections of tape provided by the first material drive/supply unit and by the second material drive/supply unit, respectively.

Alternatively and preferably, it can also be provided that the method further comprises establishing, by way of an algorithm, which of the first and the second gripping means is located in a position to draw and place the next section of tape in the shortest time.

In a second aspect, a layup machine is provided for laying up and tacking sections of tape on a part to be produced, comprising: a first material drive/supply unit for supplying tape material; first gripping means for drawing sections of tape from the first material drive/supply unit and for positioning the sections of tape in guide ways; a first cutter assembly for cutting to length the section of tape from the first material drive/supply unit; a motion table; and at least one tape tacking unit for placing the sections of tape on a tooling surface of the motion table and tacking them; characterized in that the layup machine furthermore comprises a second material drive/supply unit for supplying tape material, second gripping means for drawing sections of tape from the first material drive/supply unit and for positioning the sections of tape in guide ways, and a second cutter assembly for cutting to length the sections of tape from the first material drive/supply unit.

It can preferably be provided that the first gripping means are formed by a first tape gripping mechanism, which is mounted on a first linear actuator, and the second gripping means are formed by a second tape gripping mechanism, which is mounted on a second linear actuator.

It can preferably also be provided that the first material drive/supply unit is mounted on one side of a main structure of the layup machine, and the second material drive/supply unit 3 is mounted on the opposite side.

It can also be provided in particular that the material drive/supply units, cutter assemblies, and guides are arranged in a position offset from the tape tacking unit, and wherein a mechanism is provided to rotate or displace the guides which hold the next section into a position below the tape tacking unit.

It can preferably also be provided that the first material drive/supply unit, the first tape gripping mechanism, the first linear actuator, the first cutter assembly, material guide ways, and a first tape tacking unit are comprised in a first layup head unit, and the second material drive/supply unit, the second tape gripping mechanism, the second linear actuator, the second cutter assembly, material guide ways, and a second tape tacking unit are comprised in a first layup head unit, and wherein the first layup head unit and the second layup head unit are configured to alternate during the drawing, placing, and tacking of sections of tape on the tooling surface of the motion table.

Furthermore, it can preferably be provided that the first and the second gripping means are formed by a first gripping mechanism and a second gripping mechanism of a tape gripping arrangement, which is mounted on a linear actuator, wherein the first linear actuator has a movement range which enables the first gripping mechanism to grasp material which is provided by the first material drive/supply unit, and which enables the second gripping mechanism to grasp material which is provided by the second material drive/supply unit.

The layup machine can preferably be configured to execute a method for laying up and tacking sections of tape on a part to be produced.

### BRIEF DESCRIPTION OF THE DRAWINGS

The exemplary embodiments are better comprehensible with reference to the figures and descriptions described hereafter. The components in the figures are not necessarily to scale, they primarily relate to the illustration of the fundamentals of the exemplary embodiments. In addition, it is to be noted that identical reference signs identify identical parts throughout the different views of the figures. In the figures:

FIGS. 1 to 5 show views of a layup machine and the components thereof according to a first exemplary embodiment;

FIGS. 6 to 11 show views of a layup machine and the components thereof according to a second exemplary embodiment; and

FIGS. 12 to 15 show views of a layup machine and the components thereof according to a third exemplary embodiment.

The present embodiments relate to the equipment and systems used to manufacture advanced composite components by means of the automated layup process, utilizing materials that are supplied in the form of spooled tape.

Typically, state-of-the-art automated layup systems employ several separate subsystems to perform the various functions of unwinding, feeding, cutting, placing and tacking a section of tape in position. As many of these functions typically occur in serial fashion, the net productivity of the overall layup machine is governed by the maximum speed at which the individual subsystems can operate.

The present embodiments seek to overcome the speed limitations of certain subsystems and provide significant increases in productivity of the overall system, by means of alternate machine design configurations.

Dual Gripping Mechanisms

The speed of the subsystem employed to pull a section of tape to length and position it relative to the tooling surface has a significant impact on the overall productivity of the layup machine. Typically, such systems are configured with a gripping device, which is attached to a linear actuator. The gripping device grasps the leading edge of a section of tape and pulls it along a set of guide ways to the desired length, as dictated by the layup program for the particular part being manufactured. Unfortunately, the maximum attainable velocity and acceleration of the linear actuator have practical limitations imposed by a combination of several factors, including friction, packaging restrictions and the mass of the gripper and its associated utilities. Further, the maximum attainable force that the gripping device can exert on the tape will govern the maximum rate of acceleration at which it can reliably pull the tape without slippage.

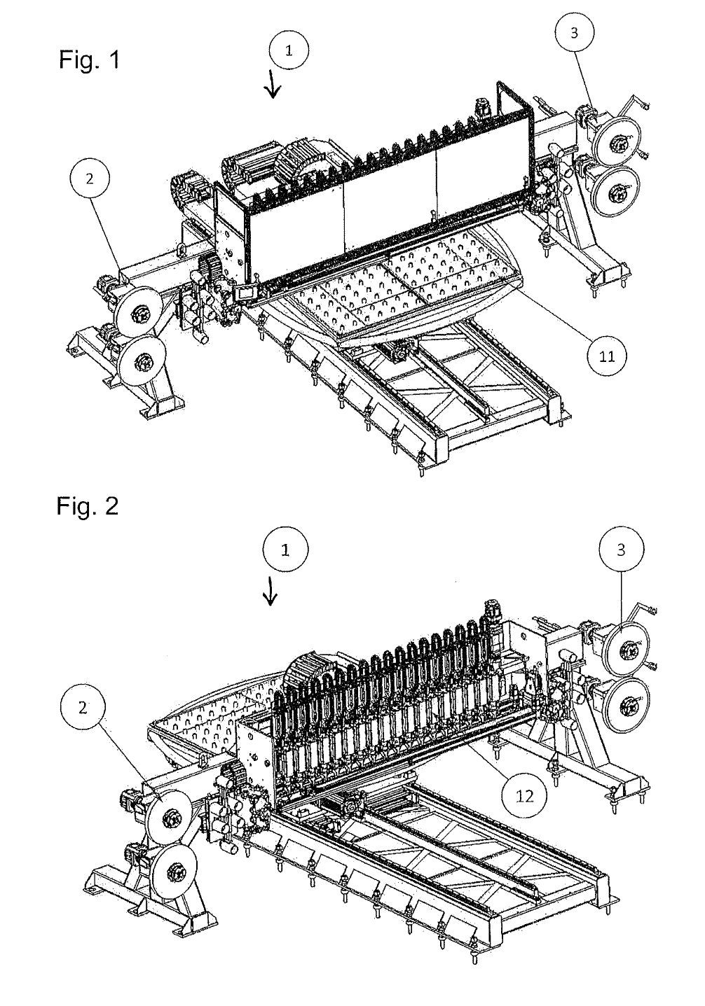

In one embodiment (see FIG. 1), the limitations described above are addressed by configuring the layup machine 1 with dual material drive/supply units 2, 3 and dual cutter assemblies 6, 7. One material drive/supply unit 2, 3 and one cutter assembly 6, 7 are located at each end of the material guide ways 10 in the layup machine 1. Additionally, the machine is equipped with dual gripping mechanisms 8, 9, each mounted to a separate linear actuator 4, 5, so as to permit one gripping mechanism 8 to access material supplied from the material drive/supply unit 2 located at one end of the layup machine 1 and the other gripping mechanism 9 to access material supplied from the material drive/supply unit 3 located at the opposite end of the layup machine 1.

With the configuration described above, after one gripping device has pulled a section of tape to length, positioned it in the guide ways 10 and begun to return to its respective material drive/supply unit 2, 3, the other gripping device can immediately begin to pull the next tape section to length from the other material drive/supply unit 2, 3 located at the opposite end of the layup machine 1. With this arrangement, the time required for either gripping device to traverse long distances in order to access the next section of tape, does not affect the productivity of the layup machine 1. It is proposed that this configuration potentially provides more significant reductions in overall process time than those provided by the currently achievable increases in the velocity and acceleration capabilities of the linear actuator 4, 5.

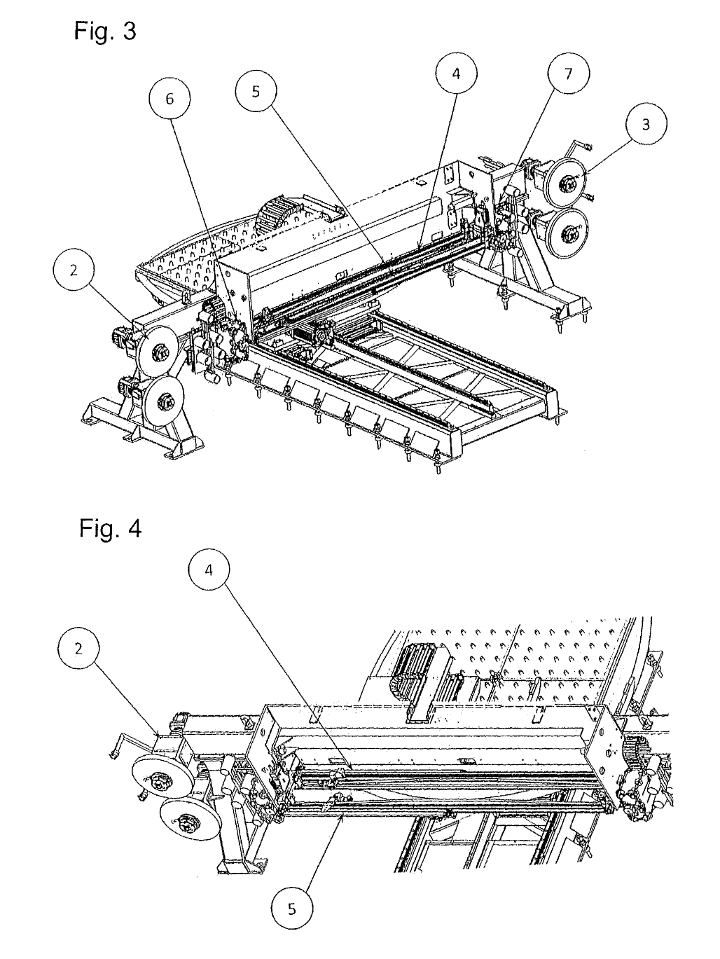

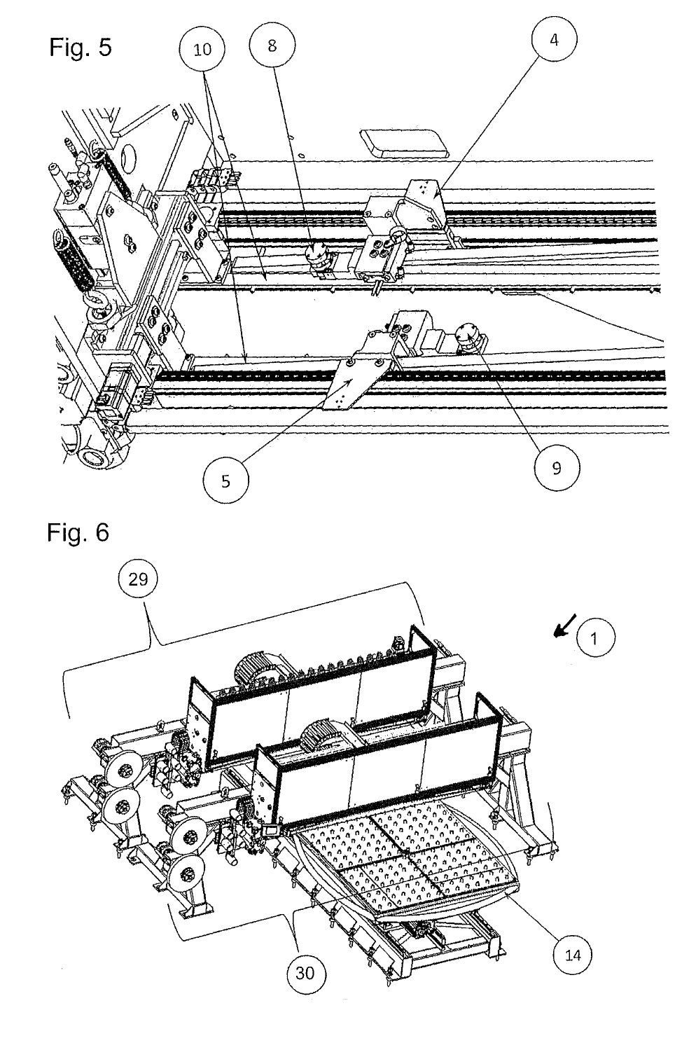

Referring to FIGS. 1 through 5, the following is a detailed description of the system:

Layup machine 1 is configured with a material drive/supply unit 2 mounted at one end of the main structure and another material drive/supply unit 3 mounted at the opposite end. A tape gripping mechanism 8 is mounted to linear actuator 4 and pulls tape sections from material drive/supply unit 2, which are cut to length by cutter assembly 6 and positioned along guide ways 10. Another tape gripping mechanism 9 is mounted to linear actuator 5 and pulls tape sections from material drive/supply unit 3, which are cut to length by cutter assembly 7 and positioned along guide ways 10. A tape tacking unit 12 is mounted to the main structure and moves upward and downward to place tape sections onto the work surface of motion table 11. Motion table 11 has the capability to move as required such that the tape sections can be placed in the desired position and orientation.

The system operates as follows:
Material drive/supply unit 2 feeds tape material to a predetermined distance beyond cutter assembly 6
Gripping mechanism 8 is actuated and grasps the leading edge of the tape section
Linear actuator 4 moves gripping mechanism 8 in a direction towards material drive/supply unit 3, for a predetermined distance, which corresponds to the desired length of the tape section
Cutter assembly 6 is actuated to sever the end of the tape section from the spool of material on material drive/supply unit 2
Linear actuator 4 continues to move gripping mechanism 8 in the direction towards material drive/supply unit 3, until the section of tape is positioned in the desired location in the guide ways 10
Simultaneously with the tape section supplied by material drive/supply unit 2 being positioned in the guide ways 10:
   Motion table 11 moves into position to receive the tape course
   Material drive/supply unit 3 feeds tape material to a predetermined distance beyond cutter assembly 7
After the section of tape supplied by material drive/supply unit 2 is placed onto the tooling surface and tacked in position by tape tacking unit 12, linear actuator 4 moves gripping mechanism 8 back to a position adjacent to cutter assembly 6
Simultaneously with gripping mechanism 8 moving back to its position adjacent to cutter assembly 6, gripping mechanism 9 is actuated and grasps the leading edge of the next tape section, which is supplied by material drive/supply unit 3
Linear actuator 5 moves gripping mechanism 9 in a direction towards material drive/supply unit 2, for a predetermined distance, which corresponds to the desired length of the next tape section
Cutter assembly 7 is actuated to sever the end of the tape section from the spool of material on material drive/supply unit 3
Linear actuator 5 continues to move gripping mechanism 9 in the direction towards material drive/supply unit 2, until the section of tape is positioned in the desired location in the guide ways 10
Simultaneously with the tape section supplied by material drive/supply unit 3 being positioned in the guide ways 10:
   Motion table 11 moves into position to receive the tape course
   Material drive/supply unit 2 again feeds tape material to a predetermined distance beyond cutter assembly 6
After the section of tape supplied by material drive/supply unit 3 is placed onto the tooling surface and tacked in position by tape tacking unit 12, linear actuator 5 moves gripping mechanism 9 back to a position adjacent to cutter assembly 7
Simultaneously with gripping mechanism 9 moving back to its position adjacent to cutter assembly 7, gripping mechanism 8 is once again actuated and grasps the leading edge of the next tape section, which is supplied by material drive/supply unit 2

The preceding sequence of events is repeated with gripping mechanisms 8 and 9 alternating the pulling and placing of tape sections supplied by material drive/supply units 2 and 3, respectively.

Besides the simple reciprocating mode described, the system can alternately be operated in an “intelligent” mode, for the occasional situation where the length of a tape section is very short and supplying a tape section from the opposite side of the layup machine 1 may consume more time than utilizing the same material drive/supply unit 2, 3 again. An algorithm determines which gripper mechanism 8, 9 is in position to pull and place the next tape section in the least amount of time, so as to optimize the efficiency of the layup process.

An alternate embodiment of the system described above is envisioned where the material drive/supply units 2, 3, cutter mechanisms, and guides may be located in a position offset from the tape tacking unit 12, rather than being in line with it. Such a configuration would provide a clear path adjacent and parallel to the tape tacking unit 12, along which each tape gripping mechanism 8, 9 could pull to length and position the next course, simultaneously with the current course being tacked in position on the work surface.

Once the tape tacking unit 12 has tacked the course in place and fully retracted, an additional mechanism would rotate or translate the guides holding the next course into position beneath the tape tacking unit 12. The guides and tape tacking unit 12 would then once again advance downward to place the new course onto the work surface and tack it in place in the usual manner.

The alternate system would operate in nearly identical fashion to the system described previously, but would offer the potential for faster cycle times by freeing the gripper mechanism 8, 9 from the restraint of having to wait until the tape tacking unit 12 fully retracted, before the next course could be pulled and placed in the guides.

With the operating configurations described above, the following benefits may be realized:
The distance and therefore unproductive time required to position the tape gripping mechanism 8, 9 for the next section of tape may be reduced, resulting in significant savings over the course of manufacturing a large lot of parts
The dual sources of material supply may reduce the amount of time lost to replenish spent spools of material. When a spool of material becomes depleted on one of the material drive/supply units 2, 3, the system is programmed to temporarily use the other material drive/supply unit 2, 3 exclusively. The depleted spool can thus be safely replaced without interruption to production.

Dual Layup Heads and Single Motion Table

The speed of the subsystem employed to pull a section of tape to length and position it relative to the tooling surface has a significant impact on the overall productivity of the layup machine. Typically, such systems are configured with a gripping device, which is attached to a linear actuator. The gripping device grasps the leading edge of a section of tape and pulls it along a set of guide ways to the desired length, as dictated by the layup program for the particular part being manufactured. Unfortunately, the maximum attainable velocity and acceleration of the linear actuator have practical limitations imposed by a combination of several factors, including friction, packaging restrictions and the mass of the gripper and its associated utilities. Further, the maximum attainable force that the gripping device can exert on the tape will govern the maximum rate of acceleration at which it can reliably pull the tape without slippage.

Another factor that has a large influence on the overall productivity of the layup machine 1 is the speed of the subsystem that is used to tack each tape section in position on the part being produced. The time required to fuse one section of thermoplastic composite tape to another is very nearly a fixed constant, the only variations being dependent on the tape thickness and resin composition. Therefore, any potential reductions in the time required to complete the tacking process must be realized from the sequence of motions required to advance the tacking subsystem into contact with the tape section and then retract it back to the home position.

As is the case with the subsystem utilized for pulling a section of tape to length and positioning it relative to the tooling surface, large-scale increases in the velocity and acceleration of the motion mechanisms are not practically achievable, due to the same factors mentioned previously; i.e., friction, packaging restrictions, and the mass of the system with its associated utilities.

In an alternate embodiment (see FIG. 6), the limitations described above are addressed by configuring the layup machine 1 with dual layup head assemblies, which are arranged so as to be accessible by a single motion table. The layup heads are independent of one another and are each configured with a dedicated material drive/supply unit 17, 18, cutter assembly 19, 20, gripping mechanism 21, 22 with associated linear actuator 23, 24, material guide ways 25, 26 and tape tacking unit 15, 16.

With the configuration described above, a section of tape can be pulled to length, positioned in the guide ways 25 and tacked in position on the part by the first layup head, simultaneously with the next section of tape being pulled to length and positioned in the guide ways 26 on the second layup head. Once the first tape section has been tacked in place by the first layup head, the motion table 14 shuttles the part to the second layup head, by which time has the next tape section prepared and in position to be tacked to the part. The motion table 14 thus constantly shuttles between the two layup heads to receive each new tape section without having to sit idly while the gripping mechanism 21, 22 completes its task of pulling a tape section to length and positioning it in the guide ways 25, 26.

With this arrangement, neither the time required for a gripping device to traverse long distances in order to access the next section of tape, nor the time required to retract the tape tacking system, will significantly affect the productivity of the layup machine 1. It is proposed that this configuration potentially provides more significant reductions in overall process time than those provided by the currently achievable increases in the velocity and acceleration capabilities of the linear actuators 23, 24 employed to position a gripping mechanism 21, 22 or a tape tacking unit 15, 16.

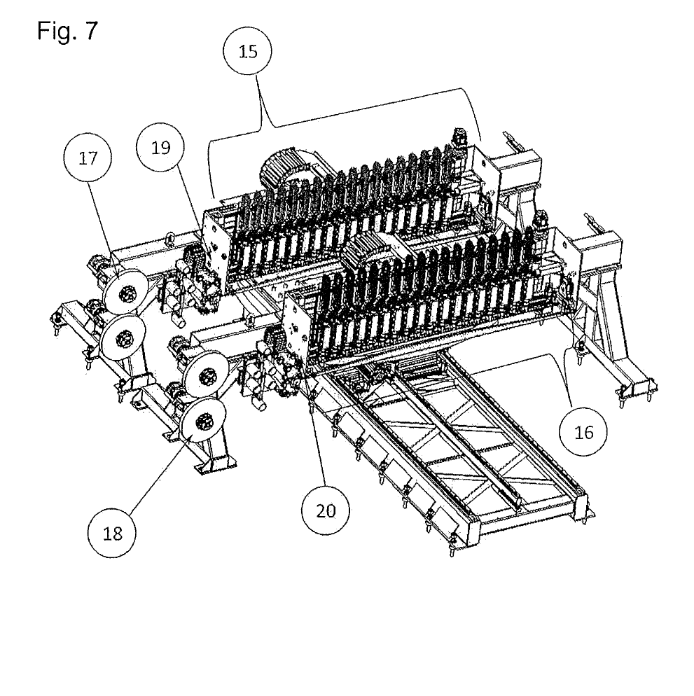

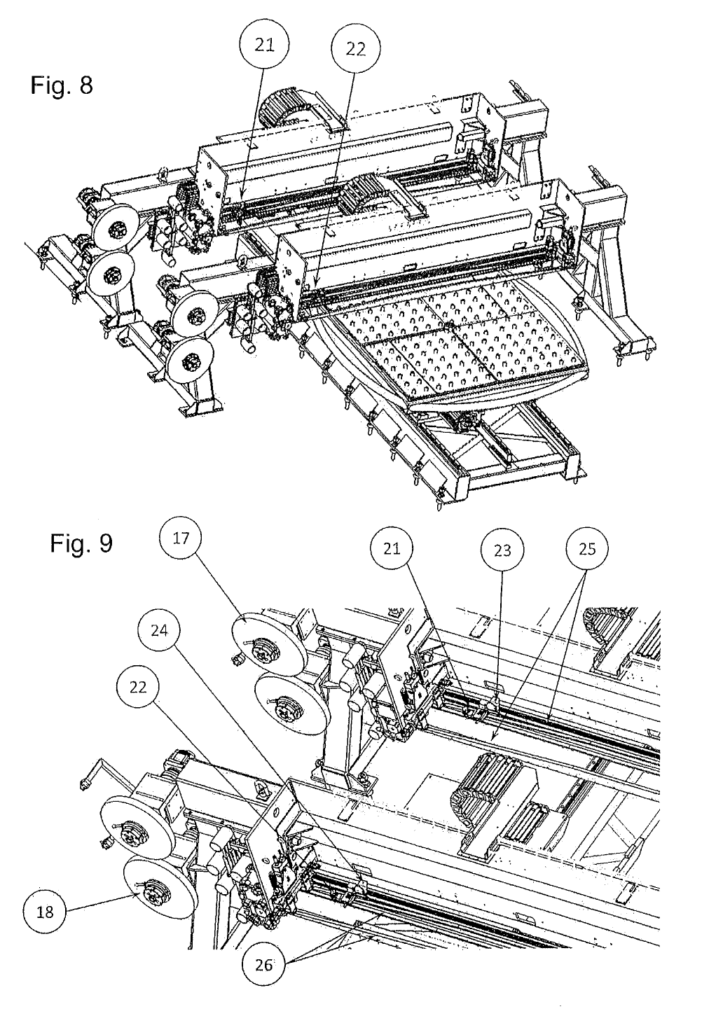

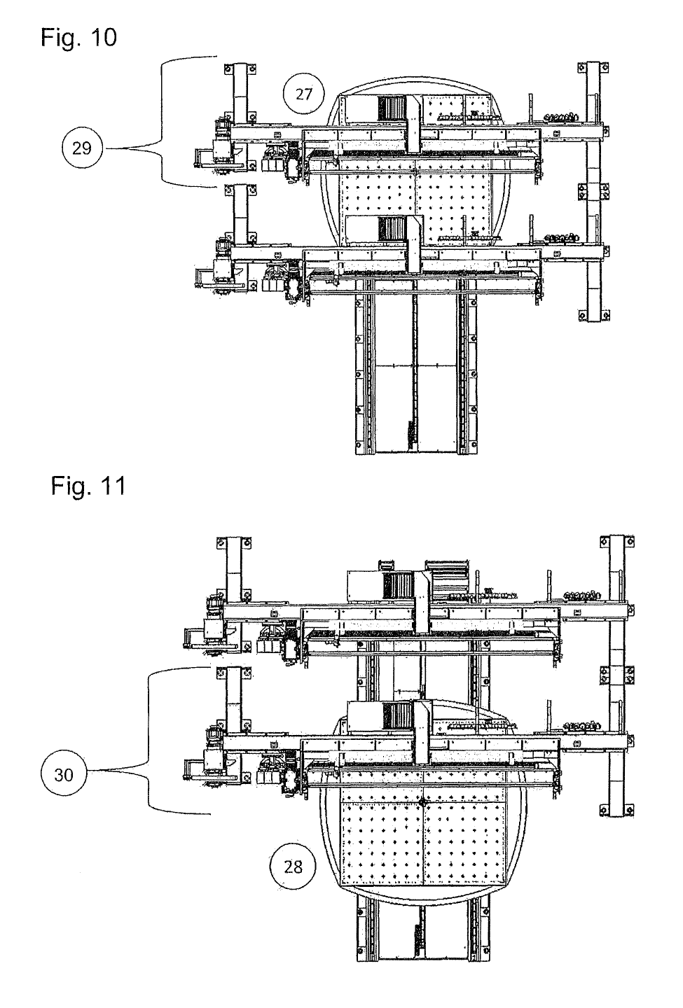

Referring to FIGS. 6 through 11, the following is a detailed description of the system:

Layup machine 11 is configured with a first layup head unit 29, a second layup head unit 30 and a motion table unit 14. First layup head unit 29 includes a material drive/supply unit 17, a cutter assembly 19, a tape tacking unit 15, a gripper mechanism 21, a linear actuator 23, and material guide ways 25.

Second layup head unit 30 includes a material drive/supply unit 18, a cutter assembly 20, a tape tacking unit 16, a gripper mechanism 22, a linear actuator 24, and material guide ways 26.

The motion table 14 can rotate about a central axis and can also translate along a linear slide with sufficient range of travel to position any location on its tooling surface, such that tape sections can be placed by either first layup head unit 29 or second layup head unit 30 at the desired location and orientation.

The system operates as follows:
Material drive/supply unit 17 feeds tape material to a predetermined distance beyond cutter assembly 19
Gripping mechanism 21 is actuated and grasps the leading edge of the tape section
Linear actuator 23 moves gripping mechanism 21 in a direction away from cutter assembly 19 for a predetermined distance, which corresponds to the desired length of the tape section
Cutter assembly 19 is actuated again to sever the end of the tape section from the spool of material on material drive/supply unit 17
Linear actuator 23 continues to move gripping mechanism 21 in the direction away from cutter assembly 19, until the section of tape is positioned in the desired location in the guide ways 25
Simultaneously with gripping mechanism 21 positioning the tape section from material drive/supply unit 17 in the desired location in the guide ways 25:
   Motion table 14 moves to position 27 beneath first layup head unit 29
   Material drive/supply unit 18 on second layup head unit 30 feeds tape material to a predetermined distance beyond cutter assembly 20
   Gripping mechanism 22 is actuated and grasps the leading edge of the tape section from material drive/supply unit 18
The tape section from the spool of material on material drive/supply unit 17 is placed on the tooling surface of motion table 14 and tape tacking unit 15 advances down to contact the tape and tack it in position on the part being produced
Simultaneously with the tape section from material drive/supply unit 17 being tacked in position:
   Linear actuator 24 moves gripping mechanism 22 in a direction away from cutter assembly 20 for a predetermined distance, which corresponds to the desired length of the next tape section
   Cutter assembly 20 is actuated again to sever the end of the tape section from the spool of material on material drive/supply unit 18
After the section of tape supplied by material drive/supply unit 17 is tacked in place:
   Tape tacking unit 15 retracts simultaneously with linear actuator 23 moving gripping mechanism 21 back to a position adjacent to cutter assembly 19
   Motion table 14 shuttles to position 28 beneath second layup head unit 30
Simultaneously with motion table 14 moving to position 28:
   Linear actuator 24 continues to move gripping mechanism 22 in the direction away from cutter assembly 20, until the section of tape is positioned in the desired location in the guide ways 26
With motion table 14 at position 28, the tape section from the spool of material on material drive/supply unit 18 is placed on the tooling surface of motion table 14 and tape tacking unit 16 advances down to contact the tape and tack it in position on the part being produced
Simultaneously with the tape section from material drive/supply unit 18 being tacked in position:
   Linear actuator 23 again moves gripping mechanism 21 in a direction away from cutter assembly 19 for a predetermined distance, which corresponds to the desired length of the next tape section
   Cutter assembly 19 is actuated again to sever the end of the tape section from the spool of material on material drive/supply unit 17
After the section of tape supplied by material drive/supply unit 18 is tacked in place:
   Tape tacking unit 16 retracts simultaneously with linear actuator 24 moving gripping mechanism 22 back to a position adjacent to cutter assembly 20
   Motion table 14 shuttles back to position 27 beneath first layup head unit 29
Simultaneously with motion table 14 moving back to position 27:
   Linear actuator 23 continues to move gripping mechanism 21 in the direction away from cutter assembly 19, until the section of tape is positioned in the desired location in the guide ways 25

The preceding sequence of events is repeated continually, with first layup head unit 29 and second layup head unit 30 alternating the pulling, placing and tacking of tape sections on the tooling surface of motion table 14.

An alternate embodiment of the system described above is envisioned where the material drive/supply units 17, 18, cutter mechanisms and guides on each layup head may be located in a position offset from its respective tape tacking unit 15, 16, rather than being in line with it. Such a configuration would provide a clear path adjacent and parallel to each tape tacking unit 15, 16, along which each tape gripping mechanism 21, 22 could pull to length and position the next course, simultaneously with the current course being tacked in position on the work surface.

Once the tape tacking unit 15, 16 has tacked the course in place and fully retracted, an additional mechanism would rotate or translate the guides holding the next course into position beneath the tape tacking unit 15, 16. The guides and tape tacking unit 15, 16 would then once again advance downward to place the new course onto the work surface and tack it in place in the usual manner.

The alternate system would operate in nearly identical fashion to the system described previously, but would offer the potential for faster cycle times by freeing the gripper mechanism from the restraint of having to wait until the tape tacking unit fully retracted, before the next course could be pulled and placed in the guides.

With the operating configuration described above, the following benefits may be realized:
The unproductive time required to position the tape gripping mechanism 21, 22 for the next section of tape may be removed from the production cycle time, resulting in significant savings over the course of manufacturing a large lot of parts
The unproductive time required to retract the tape tacking unit 15, 16 away from the tooling surface of the motion table 14 may be removed from the production cycle time, also resulting in significant savings over the course of manufacturing a large lot of parts
The dual sources of material supply may reduce the amount of time lost to replenish spent spools of material. When a spool of material becomes depleted on one of the material drive/supply units 2, 3, the system may be programmed to temporarily use the other layup head unit 29, 30. The depleted spool can thus be safely replaced without interruption to production.

Two-Sided Gripper

The speed of the subsystem employed to pull a section of tape to length and position it relative to the tooling surface has a significant impact on the overall productivity of the layup machine. Typically, such systems are configured with a gripping device, which is attached to a linear actuator. The gripping device grasps the leading edge of a section of tape and pulls it along a set of guide ways to the desired length, as dictated by the layup program for the particular part being manufactured. Unfortunately, the maximum attainable velocity and acceleration of the linear actuator have practical limitations imposed by a combination of several factors, including friction, packaging restrictions and the mass of the gripper and its associated utilities. Further, the maximum attainable force that the gripping device can exert on the tape will govern the maximum rate of acceleration at which it can reliably pull the tape without slippage.

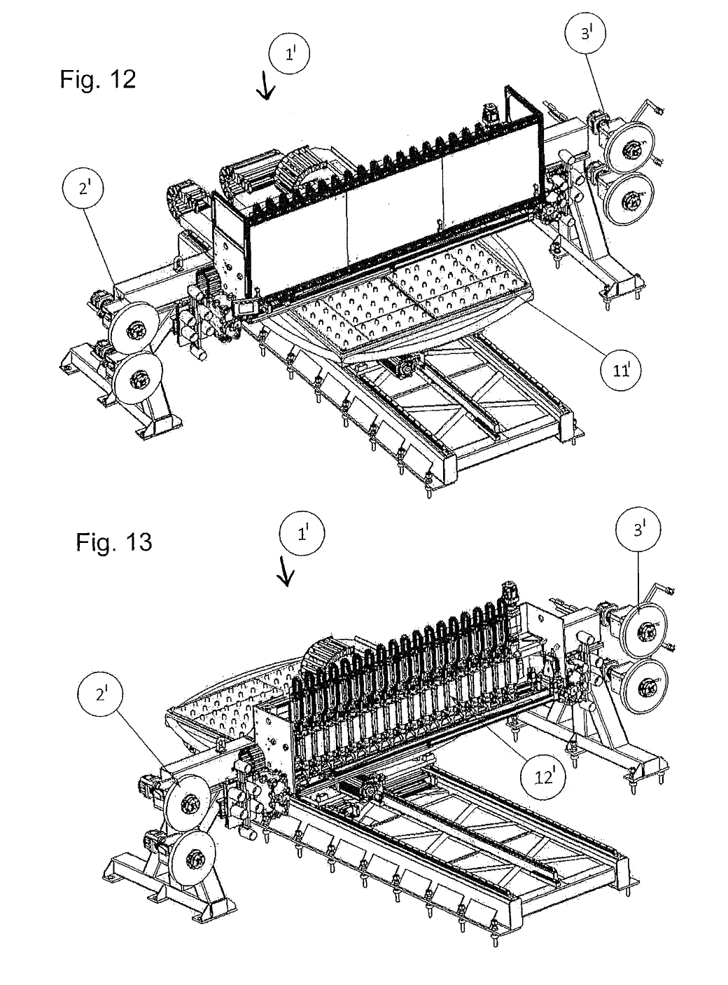

In one embodiment (see FIG. 12), the limitations described above are addressed by configuring the layup machine 1′ with dual material drive/supply 2′, 3′ units and dual cutter assemblies 6′, 7′. One material drive/supply unit 2′, 3′ and one cutter assembly 6′, 7′ are located at each end of the material guide ways 10′ in the layup machine 1′. Additionally, the gripping device is equipped with dual, back-to-back, gripping mechanisms. Further, the linear actuator 32 has sufficient range of travel to permit one gripping mechanism 8′ to access material supplied from the material drive/supply unit 2′ at one end of the layup machine 1′ and the other gripping mechanism 9′ to access material supplied from the material drive/supply unit 3′at the opposite end of the layup machine 1′.

With the configuration described above, after the gripping device has pulled a section of tape to length and positioned it in the guide ways 10′, it is already very nearly in position to pull the next section of tape out from the opposite end of the layup machine 1′. This arrangement eliminates the requirement for the gripping device to traverse long distances in order to access the next section of tape. It is proposed that this configuration potentially provides more significant reductions in overall process time than those provided by the currently achievable increases in the velocity and acceleration capabilities of the linear actuator.

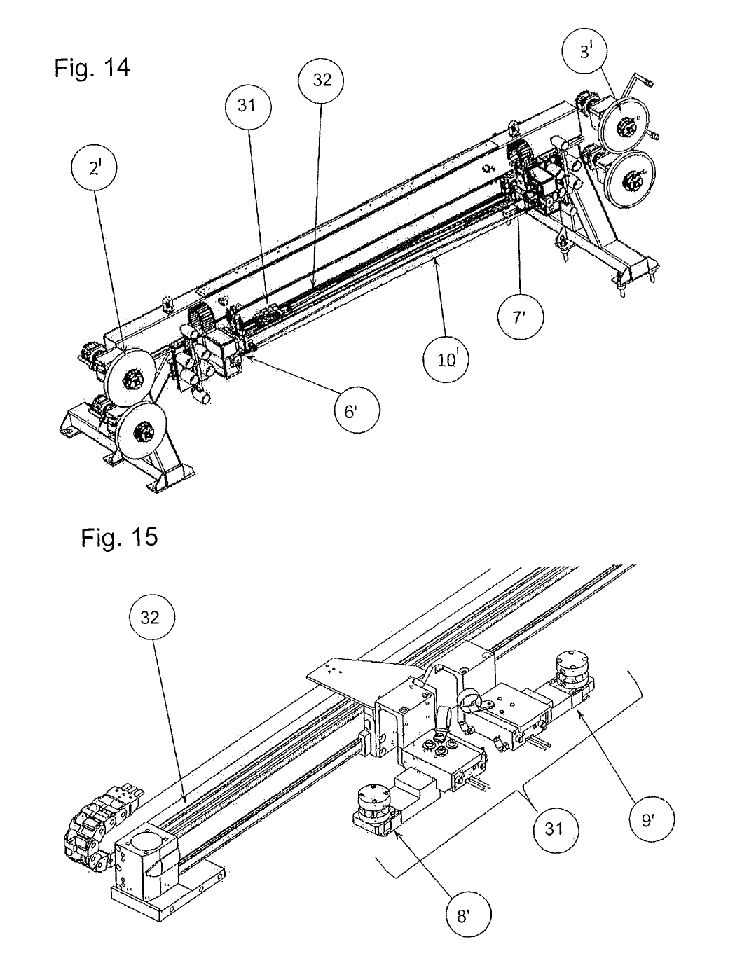

Referring to FIGS. 12 through 15, the following is a detailed description of the system:

Layup machine 1′ is configured with a material drive/supply unit 2′ mounted at one end of the main structure and another material drive/supply unit 3′ mounted at the opposite end. The tape gripping assembly 4′ pulls tape sections to the desired length, along guide ways 10′. Tape gripping assembly 4′ includes a gripper 7′ for grasping tape sections supplied from material drive/supply unit 2′ and a gripper 8′ for grasping tape sections supplied from material drive/supply unit 3′.

Tape gripping assembly 4′ is moved along guide ways 10′ by linear actuator 9′. Tape sections supplied from material drive/supply unit 2′ are cut to length by cutter assembly 5′ and tape sections supplied from material drive/supply unit 3′ are cut to length by cutter assembly 6′. A tape tacking unit 12′ is mounted to the main structure and moves upward and downward to place tape sections onto the work surface of motion table 11′. Motion table 11′ has the capability to move as required such that the tape sections can be placed in the desired position and orientation.

The system operates as follows:
Material drive/supply unit 2′ feeds tape material to a predetermined distance beyond cutter assembly 5′
Gripper 7′ on gripping assembly 4′ is actuated and grasps the leading edge of the tape section
Linear actuator 9′ moves gripping assembly 4′ in a direction towards material drive/supply unit 3′, for a predetermined distance, which corresponds to the desired length of the tape section
Cutter assembly 5′ is actuated to sever the end of the tape section from the spool of material on material drive/supply unit 2′
Linear actuator 9′ continues to move gripping assembly 4′ in the direction towards material drive/supply unit 3′, until the section of tape is positioned in the desired location in the guide ways 10′
Simultaneously with the tape section supplied by material drive/supply unit 2′ being positioned in the guide ways 10′, motion table 11′ moves into position to receive the tape course
After the section of tape is placed onto the tooling surface and tacked in position by tape tacking unit 12′:
   Material drive/supply unit 3′ feeds tape material to a predetermined distance beyond cutter assembly 6′
   Linear actuator 9′ moves gripping assembly 4′ the remaining distance to place it in position to access material supplied by material drive/supply unit 3′
Gripper 8′ on gripping assembly 4′ is actuated and grasps the leading edge of the tape section
Linear actuator 9′ moves gripping assembly 4′ in a direction back towards material drive/supply unit 2′, for a predetermined distance, which corresponds to the desired length of the next tape section
Cutter assembly 6′ is actuated to sever the end of the tape section from the spool of material on material drive/supply unit 3′
Linear actuator 9′ continues to move gripping assembly 4′ in the direction towards material drive/supply unit 2′, until the section of tape is positioned in the desired location in the guide ways 10′
Simultaneously with the tape section supplied by material drive/supply unit 3′ being positioned in the guide ways 10′, motion table 11′ moves into position to receive the tape course
After the section of tape is placed onto the tooling surface and tacked in position·by tape tacking unit 12′:
   Material drive/supply unit 2′ again feeds tape material to a predetermined distance beyond cutter assembly 5′
   Linear actuator 9 moves gripping assembly 4′ the remaining distance to place it in position to access material supplied by material drive/supply unit 2′

The preceding sequence of events is repeated, with linear actuator 9′ reversing direction after each section of tape is placed and grippers 7′ and 8′ alternating pulling tape sections from material drive/supply units 2′ and 3′, respectively.

Besides the simple reciprocating mode described, the system can alternately be operated in an “intelligent” mode, for the occasional situation where the length of a tape section is very short and moving the gripping assembly to the opposite side may consume more time than returning to the same material drive/supply unit 2′, 3′ again. An algorithm determines which material drive/supply unit 2′, 3′ is closer to the gripping assembly, in order to minimize the required traverse time to reach a material drive/supply unit 2′, 3′.

With the operating configurations described above, the following benefits may be realized:

The distance and therefore unproductive time required to position the tape gripping mechanism 8′, 9′ for the next section of tape may be reduced, resulting in significant savings over the course of manufacturing a large lot of parts

The dual sources of material supply may reduce the amount of time lost to replenish spent spools of material. When a spool of material becomes depleted on one of the material drive/supply units 2′, 3′, the system is programmed to temporarily use the other material drive/supply unit 2′, 3′ exclusively. The depleted spool can thus be safely replaced without interruption to production.

The foregoing disclosure of the embodiments has been presented for purposes of illustration and description. It is not intended to be exhaustive or to limit other embodiments to the precise forms disclosed. Many variations and modifications of the embodiments described herein will be apparent to one of ordinary skill in the art in light of the above disclosure. The scope of the embodiments is to be defined only by the claims, and by their equivalents.

Further, in describing representative embodiments of the present embodiments, the specification may have presented the method and/or process of the present embodiments as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present embodiments should not be limited to the performance of their steps in the order written, and one skilled in the art can readily appreciate that the sequences may be varied and still remain within the spirit and scope of the present embodiments.

The exemplary embodiments provide systems and methods for increasing the laying up rate of an automated layup system. The exemplary embodiments can be applied in particular to the methods and systems which are disclosed in U.S. patent application Ser. No. 13/557,621, filed on 25 Jul. 2012, which is incorporated in its entirety in this document.

Other systems, methods, features, and advantages of the exemplary embodiments are apparent or can be readily inferred for a person skilled in the art in the relevant field after examining the following figures and the detailed description. It is intended that all such additional systems, methods, features, and advantages be incorporated in this description and in this summary, be part of the range of validity of the exemplary embodiments, and be protected by the patent claims.

### LIST OF REFERENCE NUMERALS: P0164WO

1; 1′ layup machine

2, 2′ material drive/supply unit

3, 3′ material drive/supply unit

4 linear actuator

5 linear actuator

6; 6′ cutter assembly

7; 7′ cutter assembly

8, 8′ gripping mechanism

9, 9′ gripping mechanism

10; 10′ guide ways

11; 11′ motion table

12; 12′ tape tacking unit

13

14 motion table

15 tape tacking unit

16 tape tacking unit

17 material drive/supply unit

18 material drive/supply unit

19 cutter assembly

20 cutter assembly

21 gripping mechanism

22 gripping mechanism

23 linear actuator

24 linear actuator

25 guide ways

26 guide ways

27 position

28 position

29 layup head unit

30 layup head unit

31 tape gripping arrangement

32 linear actuator

1. A method for laying up and tacking sections of tape on a part to be produced, comprising:
supplying tape material using a first material drive/supply unit to a predetermined distance beyond a first cutter assembly;
grasping a leading edge of a section of tape from the first material drive/supply unit using a first gripping unit;
moving the first gripping unit over a distance, which corresponds to a desired length of the section of tape, in a direction away from the first cutter assembly;
severing an end of the section of tape from the first material drive/supply unit using the first cutter assembly;
moving the first gripping unit further in the direction away from the first cutter assembly until the section of tape is positioned at a desired point in guide ways;
moving a motion table a first time into a position to receive a tape course;
placing the section of tape provided by the first material drive/supply unit on a tooling surface of the motion table and tacking it by way of a first tape tacking unit;
moving the first gripping unit back into a position adjoining the first cutter assembly;
supplying tape material using a second material drive/supply unit to a predetermined distance beyond a second cutter assembly;
grasping a leading edge of a second section of tape from the second material drive/supply unit using a second gripping unit;
moving the second gripping unit over a distance, which corresponds to a desired length of the second section of tape, in a direction away from the second cutter assembly
severing an end of the second section of tape from the second material drive/supply unit using the second cutter assembly;
moving the second gripping unit further in the direction away from the second cutter assembly until the second section of tape is positioned at a desired point in guide ways;
moving the motion table a second time into a position to receive a second tape course;
placing the second section of tape provided by the second material drive/supply unit on the tooling surface of the motion table and tacking it by way of the first tape tacking unit or a second tape tacking unit; and
moving the second gripping unit back into a position adjoining the second cutter assembly.

2. The method according to claim 1, wherein the first movement of moving the motion table the first time into the position to receive the tape course is performed simultaneously with the positioning of the section of tape supplied by the first material drive/supply unit in the guide ways, and
moving the motion table the second time into the position to receive the tape course is performed simultaneously with the positioning of the second section of tape supplied by the second material drive/guide unit in the guide ways.

3. The method according to claim 2, wherein
the first gripping unit is formed by a first gripping mechanism, which is mounted on a first linear actuator,
the second gripping unit is formed by a second gripping mechanism, which is mounted on a second linear actuator,
supplying tape material using the second material drive/supply unit to the predetermined distance beyond the second cutter assembly is performed simultaneously with positioning the section of tape supplied by the first material drive/supply unit in the guide ways, and
supplying tape material using the first material drive/supply unit to the predetermined distance beyond the first cutter assembly is performed simultaneously with positioning the second section of tape supplied by the second material drive/supply unit in the guide ways.

4. The method according to claim 2, wherein the first gripping unit and the second gripping unit are formed by a first gripping mechanism and a second gripping mechanism, respectively, of a tape gripping arrangement, which is mounted on a first linear actuator, wherein
the first linear actuator has a movement range which enables the first gripping mechanism to grasp material which is provided by the first material drive/supply unit, and which enables the second gripping mechanism to grasp material which is provided by the second material drive/supply unit,
after placing the section of tape provided by the first material drive/supply unit on the tooling surface of the motion table and tacking by way of the first tape tacking unit, supplying tape material using the second material drive/supply unit to the predetermined distance beyond the second cutter assembly is performed and the first linear actuator moves the tape gripping arrangement over a remaining distance to place it in position for accessing material provided by the second material drive/supply unit, and
after placing the section of tape provided by the second material drive/supply unit on the tooling surface and tacking by way of the first tape tacking unit or the second tape tacking unit, supplying tape material using the first material drive/supply unit to predetermined distance beyond the first cutter assembly is performed and the first linear actuator moves the tape gripping arrangement over a remaining distance to place it in position for accessing material provided by the first material drive/supply unit.

5. The method according to claim 1, wherein the first gripping unit is formed by a first gripping mechanism, which is mounted on a first linear actuator;
the second gripping unit is formed by a second gripping mechanism, which is mounted on a second linear actuator;
the first material drive/supply unit, the first gripping mechanism, the first linear actuator, the first cutter assembly, guide ways for the material, and the first tape tacking unit are comprised in a first layup head unit;
the second material drive/supply unit, the second gripping mechanism, the second linear actuator, the second cutter assembly, guide ways for the material, and the second tape tacking unit are comprised in a second layup head unit;
the first layup head unit and the second layup head unit are configured to alternate during drawing, placing, and tacking of sections of tape on the tooling surface of the motion table;
simultaneously with the positioning of the section of tape supplied by the first material drive/supply unit in the guide ways, the following steps are performed:
moving the motion table the first time into the position for receiving the tape course to a position below the first layup head unit,
supplying tape material using the second material drive/supply unit to the predetermined distance beyond the second cutter assembly, and
grasping the leading edge of the second section of tape from the second material drive/supply unit using the second gripping mechanism;
during the tacking of the section of tape provided by the first material drive/supply unit by the first tape tacking unit, the following steps are performed:
grasping the leading edge of the second section of tape from the second material drive/supply unit using the second gripping mechanism,
moving the gripping mechanism over the distance, which corresponds to the desired length of the second section of tape, in the direction away from the second cutter assembly, and
severing the end of the second section of tape from the material drive/supply unit using a second cutter assembly; and
during the tacking of the second section of tape provided by the second material drive/supply unit by the second tape tacking unit, the following steps are performed:
moving the first gripping mechanism over the distance, which corresponds to the desired length of the section of tape, in the direction away from the first cutter assembly, and
severing the end of the section of tape from the first material drive/supply unit using the first cutter assembly are performed.

6. The method according to claim 5, wherein
after the tacking of the section of tape provided by the first material drive/supply unit by way of the first tape tacking unit
the first tape tacking unit retracts, while moving the first gripping mechanism back into the position adjoining the first cutter assembly, and
the motion table returns to a position below the second layup head unit;
while the motion table moves to the position below the second layup head unit, the first gripping mechanism moves further in the direction away from the first cutter assembly, until the section of tape is positioned at the desired point in the guide ways;
after the tacking of the second section of tape provided by the second material drive/supply unit by way of the second tape tacking unit, the following steps are performed:
the second tape tacking unit retracts, while moving the second gripping mechanism back into the position adjoining the second cutter assembly, and
the motion table returns to the position below the first layup head unit; and
while the motion table moves to the position below the first layup head unit, the first gripping mechanism moves further in the direction away from the first cutter assembly, until the section of tape is positioned at the desired point in the guide ways.

7. The method according to claim 1, wherein the first gripping unit and the second gripping unit alternately draw the section of tape provided by the first material drive/supply unit or the second section of tape provided by the second material drive/supply unit, respectively.

8. The method according to claim 1, further comprising establishing, by way of an algorithm, which of the first gripping unit and the second gripping unit are located in a position to draw and place a next section of tape in the shortest time.

9. A layup machine for laying up and tacking sections of tape on a part to be produced, comprising:
a first material drive/supply unit for supplying tape material;
a first gripping unit for drawing sections of tape from the first material drive/supply unit and for positioning the sections of tape in guide ways;
a first cutter assembly for cutting to length a section of tape from the first material drive/supply unit;
a motion table;
at least one tape tacking unit for placing sections of tape on a tooling surface of the motion table and for tacking the sections of tape;
a second material drive/supply unit for supplying tape material;
a second gripping unit for drawing sections of tape from the second material drive/supply unit and for positioning the sections of tape in guide ways; and
a second cutter assembly for cutting to length a second section of tape from the second material drive/supply unit.

10. The layup machine according to claim 9, wherein the first gripping unit is formed by a first gripping mechanism, which is mounted on a first linear actuator, and the second gripping unit is formed by a second gripping mechanism, which is mounted on a second linear actuator.

11. The layup machine according to claim 9, wherein the first material drive/supply unit is mounted on one side of a main structure of the layup machine, and the second material drive/supply unit is mounted on an opposite side of the main structure of the layup machine.

12. The layup machine according to claim 9, wherein the first and second material drive/supply units, the first and second cutter assemblies, and guide ways are arranged in a position offset from the at least one tape tacking unit, and
wherein a mechanism is provided to rotate or displace the guide ways, which hold a next section of tape, into a position below the at least one tape tacking unit.

13. The layup machine according to claim 10, wherein
the at least one tape tacking unit comprises a first tape tacking unit and a second tape tacking unit,
the first material drive/supply unit, the first gripping mechanism, the first linear actuator, the first cutter assembly, guide ways for the material, and the first tape tacking unit are comprised in a first layup head unit,
the second material drive/supply unit, the second gripping mechanism, the second linear actuator, the second cutter assembly, guide ways for the material, and the second tape tacking unit are comprised in a second layup head unit, and
the first layup head unit and the second layup head unit are configured to alternate during drawing, placing, and tacking of sections of tape on the tooling surface of the motion table.

14. The layup machine according to claim 9, wherein the first and the second gripping units are formed by a first gripping mechanism and a second gripping mechanism, respectively, of a tape gripping arrangement, which is mounted on a linear actuator, and
the linear actuator has a movement range which enables the first gripping mechanism to grasp material which is provided by the first material drive/supply unit, and which enables the second gripping mechanism to grasp material which is provided by the second material drive/supply unit.

15. The layup machine according to claim 9, wherein the layup machine is configured to execute a method for laying up and tacking sections of tape on a part to be produced, comprising:
supplying tape material using the first material drive/supply unit to a predetermined distance beyond the first cutter assembly;
grasping a leading edge of a section of tape from the first material drive/supply unit using the first gripping unit;
moving the first gripping unit over a distance which corresponds to a desired length of the section of tape, in a direction away from the first cutter assembly;
severing an end of the section of tape from the first material drive/supply unit using the first cutter assembly;
moving the first gripping unit further in the direction away from the first cutter assembly until the section of tape is positioned at a desired point in the guide ways;
moving the motion table a first time into a position to receive a tape course;
placing the section of tape provided by the first material drive/supply unit on the tooling surface of the motion table and tacking it by way of the at least one tape tacking unit;
moving the first gripping unit back into a position adjoining the first cutter assembly;
supplying tape material using the second material drive/supply unit to a predetermined distance beyond the second cutter assembly;
grasping a leading edge of the second section of tape from the second material drive/supply unit using the second gripping unit;
moving the second gripping unit over a distance, which corresponds to a desired length of the second section of tape, in a direction away from the second cutter assembly
severing an end of the second section of tape from the second material drive/supply unit using the second cutter assembly;
moving the second gripping unit further in the direction away from the second cutter assembly until the second section of tape is positioned at a desired point in the guide ways;
moving the motion table a second time into a position to receive a second tape course;
placing the second section of tape provided by the second material drive/supply unit on the tooling surface of the motion table and tacking it by way of the at least one tape tacking unit; and
moving the second gripping mechanism back into a position adjoining the second cutter assembly.
